(19) United States
(12) Patent Application Publication
(10) Pub. No.: US 2008/0155641 A1
(43) Pub. Date: Jun. 26, 2008

(54) METHOD AND SYSTEM MANAGING A DATABASE SYSTEM USING A POLICY FRAMEWORK

(75) Inventors: Thomas A. Beavin, Milpitas, CA (US); Baoqiu Cui, San Jose, CA (US); You-Chin Fuh, San Jose, CA (US); William Y. Kyu, San Jose, CA (US); Adarsh R. Pannu, San Jose, CA (US); Lin Qiao, San Jose, CA (US); Basuki N. Soetarman, Los Gatos, CA (US)

Correspondence Address: SAWYER LAW GROUP LLP, P.O. BOX 51418, PALO ALTO, CA, 94303, US

(73) Assignee: International Business Machines Corporation, Armonk, NY (US)

(21) Appl. No.: 11/614,024

(22) Filed: Dec. 20, 2006

(51) Int. Cl. G06F 17/00

(52) U.S. Cl. 726/1

(57) ABSTRACT

A method and system for managing a computer system are described. The method and system include defining and storing a policy using a policy manager. In one aspect, the policy manager also activates and resolves conflicts between policies. The policy is a declarative statement of a directive to be carried out by the computer system. The method and system also include using a policy executor to determine whether a request to the computer system is covered by the policy. The method and system further include utilizing the computer system to carry out the directive for the policy if the request is covered by the policy through a policy enforcer.

### FIELD OF THE INVENTION

The method and system relate to data storage and retrieval systems and more particularly, to managing activities of database systems through the use of policies.

### BACKGROUND

Database systems are increasingly used for storage, organization, and accessing data. FIG. 1 depicts a conventional database system 10. For clarity, only portions of the database systems 10 are shown. The database system 10 typically includes at least one user interface (UI) 12, a database engine 14, and a storage subsystem 16. Through the UI 12, user(s) 19 can enter queries, statements in database native query language, or database requests in order to access, add to, and/or change desired portions of the data stored in the storage subsystem 16. Similarly, applications 18 may also provide database requests to the database system 10 to access, add to, and/or change desired portions of the data stored in the storage subsystem 16. Typically, such queries are executed by the database engine 14. In addition, an authorized user 19, such as a database administrator, may manage aspects of the database system 10 in order to track performance and user(s) 19, tune features of the database system 10 for improved performance, and perform other management and upkeep functions. Such managerial functions are also typically performed via the database engine 14.

Although such systems are useful, database systems 10 and database applications 18 used in conjunction with such systems 10 have grown in complexity. This increasing complexity has made it difficult to maintain the database system 10 and to optimize the performance of the database system 10. Improving the maintenance and efficiency of the database system 10 is particularly important because many businesses depend on the efficiency of their database systems 10.

Database maintenance and tuning is typically performed by one or more database administrators. A database administrator may be faced with a multitude of issues in order to optimize the performance of the database system 10. For example, in order to address performance issues, the database administrator monitors queries and deals with critical performance issues for the queries as these issues arise; tune query execution; tune access path generation for the database system; carry out data collection arid reporting; tune the database system's 10 configuration parameters; limits the use of resources so that sufficient resources remain; perform auditing of the database system 10; prioritize execution of queries; regulate access control and authorization; manage the use of resource; and perform other functions related to management and timing of the database system. Thus, the database administrators may control aspects of the database system 10 in order to maintain and tune the database system 10.

Although database administrators exist, such database tuning and diagnostic experts are scarce. Moreover, such skills are difficult and time consuming to acquire. Furthermore, the tuning and diagnostic tasks may be time consuming. The scarcity of experts and the time consuming task itself left most database systems 10 vulnerable to performance, availability, and maintenance problems. In an enterprise setting, a sub-optimal performance of the database system 10 might cause a loss or revenue or cash due to penalties for not being able to fulfill contractual agreements. At the extreme, the effect could be catastrophic for mission critical applications.

Because of the issues in relying solely on skilled database administrators, vendors of the database system 10 are generally obliged to provide tools (not specifically shown) for improving management of the database system 10. These conventional tools are provided as part of the database system 10. Typically such conventional tools aid in diagnosing, monitoring, and tuning database queries. These conventional tools may increase the effectiveness of the customers in maintaining and tuning the database system, thereby reducing the total cost ownership.

Although such conventional tools improve the ability of database administrators to manage database systems, even with the help of such conventional tools, maintenance and tuning may still be difficult. In particular, such conventional tools typically focus on global solutions. Such global solutions may not be available. The complexities of the database system 10 as well as the variety of applications 18, user(s) 19, and queries have also increased. A global solution that accounts for this increased complexity and the varying needs of applications 18 and users 19 may be difficult or impossible to attain. In addition, in some cases, solutions for a small and isolated context are more appropriate for certain problems.

Applications 18, as well as needs of user(s) 19, may vary widely. Consequently, a variety of data accessing patterns may be present. Tuning and optimization criteria for one application 18 or user 19 may not necessarily apply to other applications 18 or user 19. Moreover, criteria for activities such as tuning or optimization for different applications 18 and/or user(s) 19 might be contradictory. Optimizing the database system 18 for one application 18 or user 19 may negatively impact other applications' 18 or users' 19 use of the database system 10. Thus, an effort to fix one optimization problem might end up in creating other problems. Moreover, a system configuration parameters setup for a group of statements might not be compatible with the setup for other groups. Consequently, a generally optimum setup may be difficult to configure. A specific monitoring type focusing on a selected group of statements is often required to diagnose potential problems for these statements. Thus, different sets of database requests may each require individual monitoring. Due to the complexity of the database engine, an optimization patch that is applicable to solve a problem in a group of applications, might causes problem for other applications. Striking a balance in attaining global optimization satisfying all applications 18, queries, and/or users 19 may, therefore, be difficult even with conventional tools.

Accordingly, what is needed is a more unified method and system for addressing the multitude of issues faced by current database administrators. The present invention addresses such a need.

### BRIEF SUMMARY

A method, computer-program product, and system for managing a computer system are described. In one aspect, the system includes a policy manager for defining and storing a policy. The policy is a declarative statement of a directive to be carried out by the computer system. The system also includes a policy executor that is coupled with the policy manager and that is for determining whether the policy covers a request to the computer system. In this aspect, the system further includes a policy enforcer, coupled with the policy executor, for utilizing the computer system to carry out the directive for the policy if the policy covers the request. In another aspect, the computer system is a database system. In this aspect, the policy manager also stores the plurality of policies in a table, resolves conflicts between the plurality of policies, and performs a look-up for each of the plurality of policies. The policy executor receives database requests and determines whether each of the database requests is within the scope of at least one of the plurality of policies. In this aspect, the policy enforcer utilizes the database engine to carry out the directive for each the plurality of policies covering each of the database requests. In another aspect, the method includes defining the policy, storing the policy, determining whether a computer system request is covered by the policy, and carrying out the directive for the policy if the computer system request is covered by the policy. In another aspect, the method is used in connection with a computer system that is a database system. In this aspect, the method includes defining a plurality of policies provided by at least one of an authorized user and an application. Each of the policies corresponds to a group and includes a scope, at least one action, and at least one parameter. The action(s) correspond to a directive to be carried out by the plurality of policies, storing the plurality of policies in a table, and determining whether each of a plurality of database requests are within the scope of at least one of the plurality of policies. In this aspect, the method also includes performing a look-up for each policy having a scope within which one of the database requests is. The method also includes the database engine carrying out the directive for each policy corresponding to each of the database requests. In another aspect, computer-program product includes a program for managing performance in a computer system. In this aspect, the program includes instructions for defining the policy, storing the policy, determining whether a computer system request is covered by the policy, and carrying out the directive for the policy if the computer system request is covered by the policy. In another aspect, the computer system is a database system and the program includes instructions for receiving a plurality of policies from at least one of an authorized user and an application. Each of the policies corresponds to a group and includes a scope, at least one action, and at least one parameter. The action(s) correspond to the directive to be carried out by the database system. In this aspect, the program also includes instructions for resolving conflicts between the plurality of policies, storing the plurality of policies in a table, and determining whether the each of a plurality of database requests are within the scope of at least one of the plurality of policies. In this aspect, the method also includes performing a look-up for each policy having a scope within which one of the database requests is. The program also includes instructions for the database engine to carry out the directive for each policy covering to each of the database requests.

According to the method and system disclosed herein, management of the computer system, for example maintenance and tuning of a database system, are facilitated through the use of policies.

### BRIEF DESCRIPTION OF SEVERAL VIEWS OF THE DRAWINGS

FIG. 1 depicts a conventional database system.

FIG. 2 is a diagram depicting one embodiment of a system for managing a database system utilizing policies, as used in a database system.

FIG. 3 is a diagram depicting the relationship between policies and database activities in one exemplary embodiment of the system.

FIG. 4 is a flow chart depicting one embodiment of a method for managing a database system using policies.

FIG. 5 is a diagram depicting another embodiment of a system for managing a database system utilizing policies, as used in a database system.

FIG. 6 is a flow chart depicting another embodiment of a method for managing a database system using policies.

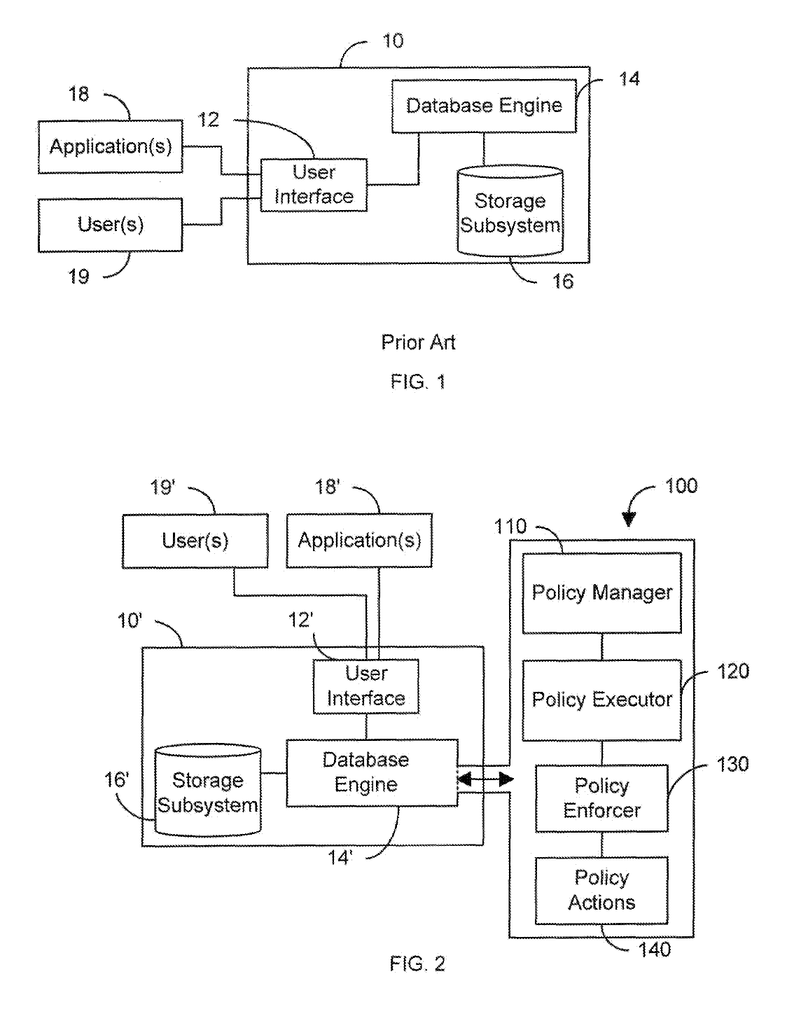

### DETAILED DESCRIPTION

The method and system relate to database systems. The following description is presented to enable one of ordinary skill in the art to make and use the method and system and is provided in the context of a patent application and its requirements. Various modifications to the embodiments and the generic principles and features described herein will be readily apparent to those skilled in the art. Thus, the method and system are not intended to be limited to the embodiments shown, but is to be accorded the widest scope consistent with the principles and features described herein.

A method and system for managing performance of a computer system are described. The method and system include defining and storing a policy using a policy manager. The policy is a declarative statement of a directive to be carried out by the computer system. The method and system also include using a policy executor to determine whether a request to the computer system is covered by the policy. The method and system further include utilizing the computer system to carry out the directive for the policy if the request is covered by to the policy, through a policy enforcer.

The method, system, and computer-program product will be described in terms of a database system. One of ordinary skill in the art will, however, recognize that the method, system, and computer-program product may be utilized with other analogous computer systems. The method, system, and computer-program product are also described in the context of particular database systems. However, one of ordinary skill in the art will recognize that other database systems may be used with the method and system described herein. The method, system, and computer-program product will also be described in terms of a system having certain components performing particular functions. However, one of ordinary skill in the art will recognize that a system having additional and/or different components may be used. The method and system are also described in the context of methods having certain steps. However, one of ordinary skill in the art will recognize that other consistent methods having different and/or additional steps that might be performed in another order may be used. The method and system are also described in the context of specific policies belonging to certain groups and having certain scopes, actions, and parameters. However, one of ordinary skill in the art will readily recognize that additional and/or different policies belonging to additional and/or different groups and having additional and/or different scopes, actions, and/or parameters may be used.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

To more particularly describe the present invention, refer to FIG. 2 depicting one embodiment of a system 100 in accordance with the present invention as used in conjunction with the database system 10′. Thus, the system 100 is preferably implemented as an extension of the database engine 14′. However, for clarity, the system 100 and database system 10′ are depicted separately. Also in a preferred embodiment, the system 100 is an extension of the engine of a relational database system. For example, the database system 10′ is preferably DB2 for z/OS. The database system 10′ corresponds to the database system 10 and thus has components labeled in an analogous manner. In addition, although only the components 12′, 14′, 16′, and 18′ are shown, nothing prevents the database system 10′ from having different and/or additional components not inconsistent with the system 100. In a preferred embodiment, the system 100 is incorporated into the database system, such as the database 10′. The system 100 includes policy manager 110, policy executor 120, and policy enforcer 130 and undertakes policy actions 140. In a preferred embodiment, at least the policy manager 110 and the policy enforcer 130 are architected as separate parts of the underlying database engine 14′ and might be delivered to the database system 10′ as plug-ins.

The system 100 is a framework that is used in connection with policies. A policy is a declarative means for expressing directives to be carried out by the underlying database system 10′, particularly the database engine 14′. The policies are thus preferably declarative in nature as opposed to procedural. This property may provide some degree of flexibility in defining polices independent of the execution engine. For example, a policy for a database system 10′ and implemented using the system 100 might include, but is not limited to one of the following:
Monitor all queries in myERP application for cardinality exceptions, when the actual cardinality differs more than 300% from the expected cardinality; report the collected statistics in details;
Queries for the personnel application should not be allowed to run for more than 3 minutes, cancel the query if this threshold is reached and generate a detailed report;
Consider using star join only for queries in data-warehousing applications;
Run all queries in myERP application in parallel, with degree=5;
Do not cache dynamic statements in package Payroll;
Maintain the list of top 100 statements and the runtime profile based on the total CPU time;
Log the statement and relevant information that attempts to access to the salary column of employee table;
Do not consider to use star join when executing this query; and
Use star join when running queries involving more than 10 tables.

### Thus, each policy is essentially a directive for certain activities to be undertaken by the underlying database system 10′ in certain circumstances.

Each policy belongs to a group. The groups correspond to the types of activities which the database system 10′ undertakes based on the policy. Stated differently, the group is a domain or area of applicability of database activities that the policy may govern. These groups might include but are not limited to activities such as:
data collection and reporting: management of the desirable level of granularity and the amount of data collection that should be performed and reported (which may be used to complement other domains that collect data and produce reports, for example query monitoring);
access control and authorization: regulation of access control to resources;
system configuration: determination of the preferred system configuration for running a specific application and/or query;
query monitoring: a determination of which queries to monitor and the kind of monitoring to perform;
resource limits: resource usage (for example limits on usage of certain resources and specification of the action to take when the resource threshold is reached);
query tuning or access path generation: guidance for the query access path generation to yield optimal performance;
prioritizing query execution: guidance for the execution priority for a query, a group of queries, or applications;
auditing: governance of what kind or part of database access require audit log.

Each policy also includes a scope, one or more actions that correspond to the directive(s), and parameters that further specify the action(s) to be taken. The scope indicates the context in which the policy should take effect. The scope, therefore, determines the extent and level of the policy impact. The scope may thus be useful for isolating a problem or solution areas. In the database system 10′, the scope may include the whole database system 10′, a specific application, a group of statements, or an individual statement only. Group of statements in a scope can be selected based on various statement properties, for example, authorization ID, IP address from where the statement is submitted, plan name, collection name, package name, transaction name, and so forth. For example, the scope might include but is not limited to a particular application or applications, a particular query, a set of queries, or all queries of the database system 10′.

The action specifies the task to be taken when the policy is in effect. In addition, the action taken reflects the directive of the policy. For example, an action might be an executable task such as

Force parallelism with degree 5;

Generate a plan without star join;

Generate a plan with start join;

Force the optimizer to use optimization hints;

Override certain configuration parameters;

Monitor the execution of certain queries; and

Limit the resource usage of certain queries.

### The parameters may be used to make the effect of the policy's action more specific, customized for a different scope level.

The system 100 uses policies to make the database system 10′ perform specific actions under specific circumstances. Through the use of policies, an action taken can focus changes to affect only a specific statement, a group of statements, applications, or the whole database system 10′. Thus, policies dictate the actions, which the underlying database system 10′ is to carry out under certain circumstances set by the policy. These directives may modify the default behavior of the database system 10′ to obtain the desired goals. Based upon their directives, policies may have broad implications for a wide variety of database activities or may be very specific.

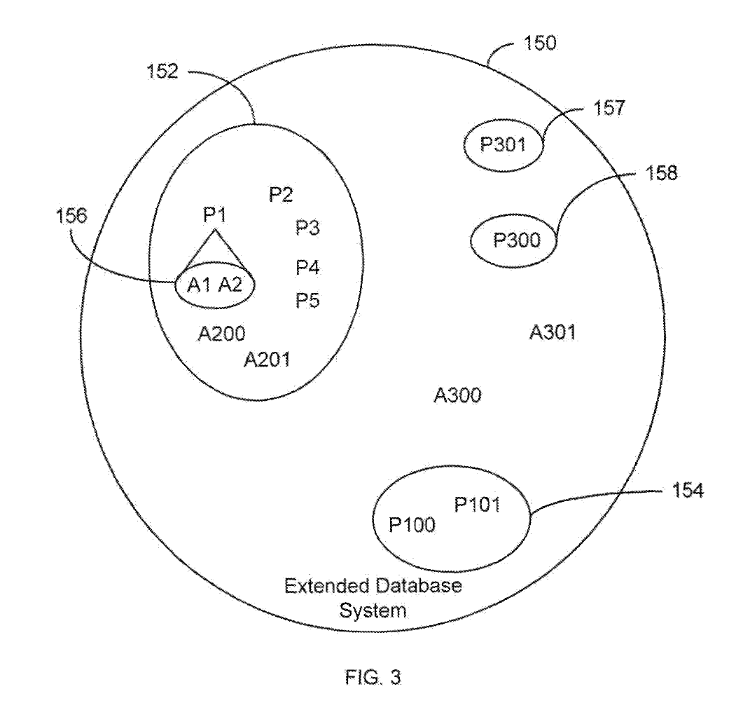

For example, FIG. 3 is a diagram depicting the relationship between policies and database activities in one exemplary embodiment of the system 10′ and 100, termed the extended database system in FIG. 3. For clarity, only a few policies and activities are depicted. All of the activities and policies in the database system including the systems 10″ and 100 fall within the set 150. For a database system, the activities A1, A2, A200, A201, A300, and A301 are generally queries, statements, or other database requests. Groups of policies 152, 154, 157, and 158 are depicted. The policies in a group 152 or 154 are related to the same activities. For example, the policies P1, P2, P3, p4, and P5 in group 152 may be related to tuning. The policies P100 and P101 and activities (not shown) in group 154 are related to something else, such as monitoring. The policies P300 and P301 may be considered to each fall within their own group 157 and 158, respectively. The activities A300 and A301 are not yet governed by policies.

The group 152 includes policies and activities. The policies P1, P2, P3, P4, and P5 and activities A1, A2, A200, and A201 shown are also related to tuning. The activities A1 and A2 are specified as being within the scope 156 of the policy P1. Thus, A1 and A2 are queries and/or statements that are related to tuning and within the scope 156 of the policy P1. Policies P2, P3, P4, and P5 also have activities (not shown) which fall within their scope. In addition, in the group 152, the activities A200 and A201 are not yet regulated by policies. Consequently, the activities A200 and A201 are related to tuning, but do not fall within the scope of existing policies.

Using the framework described herein, for example the system 100, additional policies may be added to the system 150. These additional policies might be added to an existing group such as the group 152 or 154, or may be part of a new group (not shown). The system 100 not only allows such additional policies to be defined, but also resolves any conflicts between existing policies and additional policies, and allows policies to be implemented for activities falling within their scope, as discussed below.

The system 100 includes policy manager 110, policy executor 120, and policy enforcer 130 and can be considered an extension of the underlying database engine 14′. The policy manager 110 defines policies, stores policies, and performs look-ups for policies. In a preferred embodiment, the policy manager 110 also resolves any conflicts between policies. The policy executor 120 receives database requests, such as queries or statements, and determines whether the database requests fall within the scope of the policies. The policy enforcer 130 utilizes portions of the underlying database system 10′ to carry out the directive for the policy if the database request is covered by the policy.

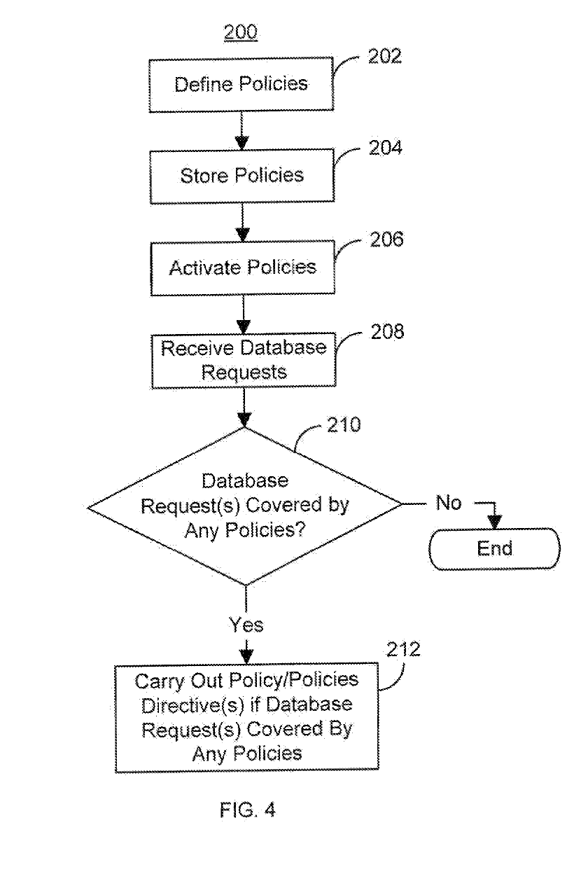

FIG. 4 is a flow chart depicting one embodiment of a method 200 for defining, activating, and carrying out policies. The method 200 is described in the context of the system 100 and database system 10′. However, the method 200 may be used in conjunction with another system (not shown) that utilizes policies to manage a computer system.

Referring to FIGS. 2 and 4, one or more policies for use in managing the database system 10′ are defined via step 202. In a preferred embodiment, step 202 includes the policies being provided either by a user 19′ and/or by application(s) 18′ via the user interface 12′. The policies may be defined by storing the policies on a file, a URL, database table, a pipe, cache memory, or other input media. As discussed above, the policies may be limited in scope or may be broad in scope. For example, the policies received in step 202 may only be applicable for database requests by the user 19′ or application(s) 18′, may relate to all requests by any user 19′ of application(s) 18′ of a specific type, or may relate to the entire database system 10′. In some embodiments, any user 19′ may be able to define policies, at least in a limited context. However, in another embodiment, only a super user 19′ such as a database administrator may define and activate policies to avoid conflicts and chaos in database operations.

The policies are stored preferably using the policy manager 110, via step 204. Step 204 preferably includes the policies being read from the input media, discussed above, by the policy manager 110 and stored. In one embodiment, any conflicts between the policies provided in step 202 and/or pre-existing policies of overlapping scope are also resolved in step 204. However, in a preferred embodiment, conflict resolution is performed when the policy is activated. In one embodiment, the policies may not be in effect, or activated, unless specified by the authorized user 19′ and/or application(s) 18′. Some or all of the policies may be activated in step 206. In a preferred embodiment, conflict resolution is thus performed in step 206. Once activated, the policies control the behavior of the database system 10′ under certain conditions.

Database requests are received, via step 208. The database requests may include a request for any activity performed by the database system 10′. Thus, database requests may include queries or statements provided to the database system 10′. In a preferred embodiment, the database requests are part of an input stream that may be provided from user(s) 19′ or one or more of the application(s) 18′ through the UI 12′.

The database requests are analyzed to determine whether some portion of the policies covers the one or more of the database requests, via step 210. Step 210, therefore, determines whether any of the database requests falls within the scope of any of the policies. Stated differently, it is determined in step 210 whether any of the database requests is affected by any of the policies. In a preferred embodiment, step 210 is performed by the policy executor 120. In particular, the policy executor 120 preferably reads the input stream(s) including the database requests and calls the policy manager 110 to perform a policy look-up to determine if the database requests match the scope of one or more of the policies.

If a database request is not covered by any policy, then the method 200 is terminated for that database request. As a result, the query or statement in the database request is executed normally by the database system 10′. However, if one or more database requests is covered by one or more of the policies, then the directives of the policies are carried out, via step 212. In addition, the database request is executed. This is preferably accomplished through the policy enforcer 130. The policy enforcer 130 selects the appropriate actions for the appropriate policies and utilizes the database system 10′, particularly the database engine 14′, to perform the actions.

Thus, using the system 100 and the method 200, policies may be provided by user(s) 19′ and/or application(s) 18′ and implemented where appropriate. The system 100 and method 200 thus provide flexible mechanism to affect the default behavior of the underlying database system 10′ towards achieving specific goals. The system 100 and method 200 may define, manage, and enforce policies related in different groups in a consistent manner. Any conflicts that arise between policies may be identified and resolved. Further, using the method 200 and system 100, it is determined whether any policies affecting the current execution scope (e.g. the database requests) and only these policies cause actions to be undertaken. Through the system 100 and method 200, policies can be used to isolate a problem into a more specific context, upon which either general or customized solutions are derived. Moreover, the user 19′ may be able to customize solutions to be applicable only for a specific scope, thereby eliminating interference between solutions. Furthermore, the declarative nature of a policy expression gives the user 19′ some degree of flexibility in defining policies independent from the database engine 12′. Moreover, the system 100 and method 200 allow for a policy framework that is open, flexible, extensible, and allows more policy domains to be added without disrupting the existing support. Because the system 100 and method 200 perform no additional functions when a database request is not within the scope of a policy, additional overhead used by the system 100 and method 200 may be limited. Although described in the context of the database system 10′ the system 100, method 200, and corresponding policies may be applicable to other computer systems and/or applications.

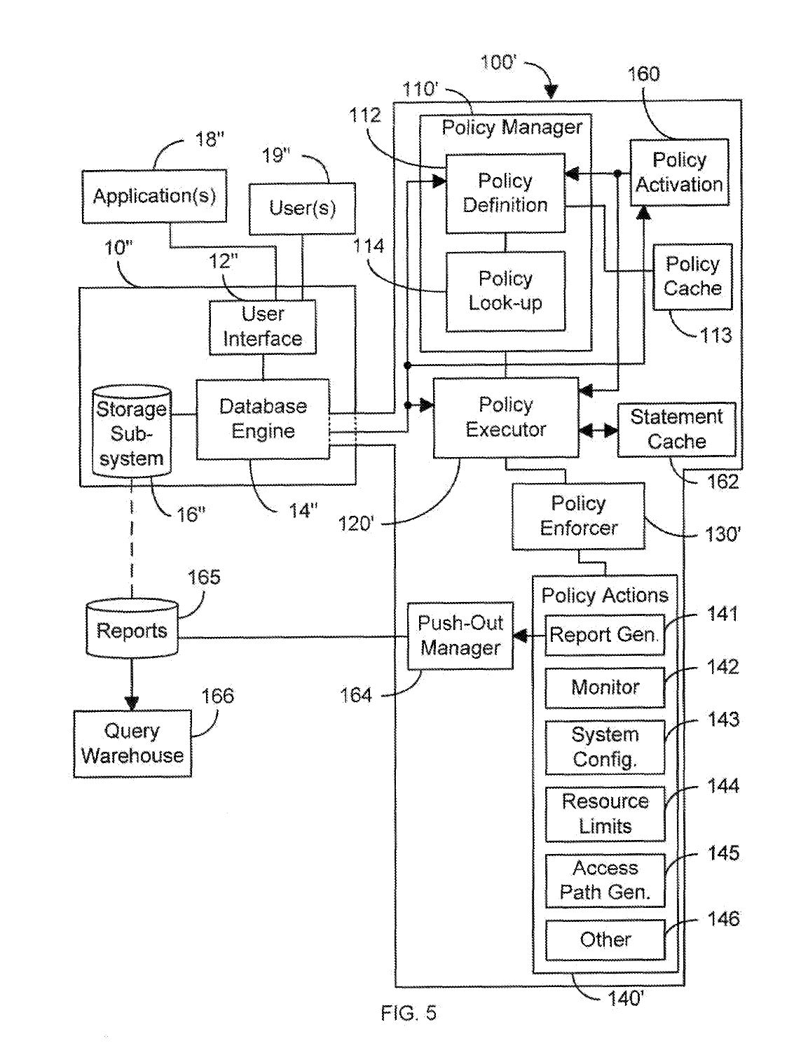

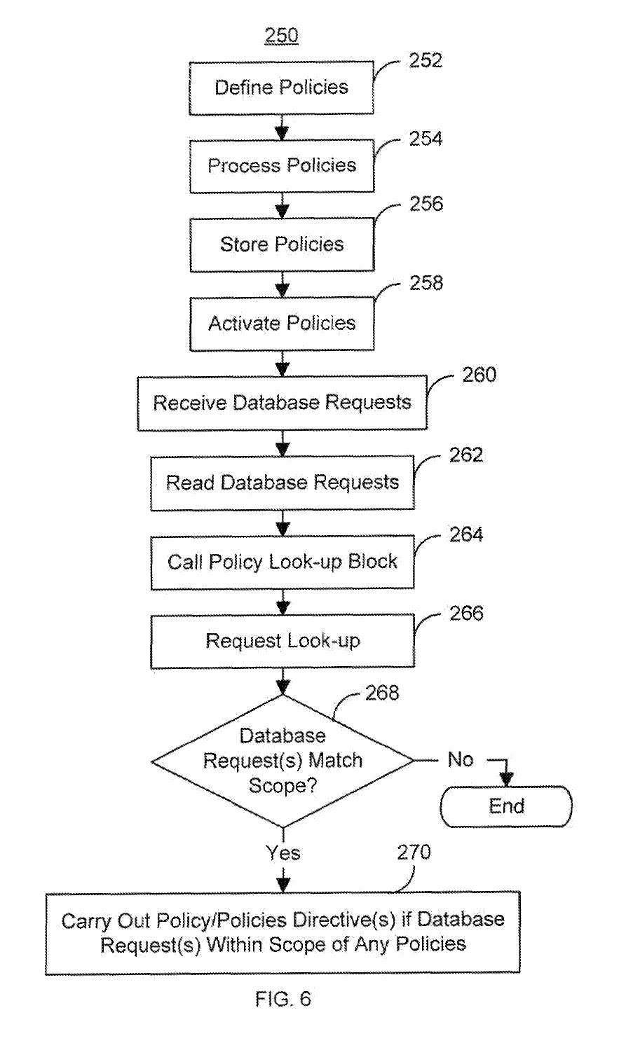

To more particularly describe one embodiment of the method and system, refer to FIGS. 5 and 6. FIG. 5 is a diagram depicting another embodiment of a system 100′ for managing a database system using policies, as used with a database system 10″. The database system 10″ corresponds to the database systems 10/10′ and thus has components labeled in an analogous manner. In addition, although only the components 12″, 14″, 16″, 18″, and 19″ are shown, nothing prevents the database system 10″ from having different and/or additional components not inconsistent with the system 100′. In a preferred embodiment, the system 100″ is incorporated into the database system, such as the database 10″. The system 100′ corresponds to the system 100 and thus has components labeled in an analogous manner. In addition, although only the components 110′, 120′, 130′, and 140′ are shown, nothing prevents the system 100′ from having different and/or additional components. The system 100′ is preferably implemented as an extension of the database engine 14″. However, for clarity, the system 100′ and database system 10″ are depicted separately. Also in a preferred embodiment, the system 100′ is an extension of the database engine of a relational database system. For example, the database system 10″ is preferably DB2 for z/OS. The system 100′ includes policy manager 110′, policy executor 120′, and policy enforcer 130′ that are analogous to the policy manager 110, policy executor 120, and policy enforcer 130, respectively. Thus, the system 100′ provides an analogous framework for the policies described above. In a preferred embodiment, at least the policy manager 110′ and the policy enforcer 130′ are architected as separate parts of the underlying database engine 14″ and might be delivered to the database system 10″ as plug-ins. In addition, policy actions 140′ includes some of the actions that may be undertaken using the system 100′ including report generation 141, monitoring 142, system configuration 143, resource limits management 144, access path generation 145, and other actions 146.

The system 100′ includes the policy manager 110′, policy executor 120′, and policy enforcer 130′ having functions that are analogous to the policy manager 110, policy executor 120, and policy enforcer 130, respectively. In addition, the policy manager 110′ includes a policy definition block 112 and a policy look-up block 114. The policy definition block 112 preferably processes and performs conflict resolution between policies. The policy definition block 112 also stores policies in a memory such as a policy cache 113 or policy tree. The policy look-up block 114 is used to look up policies to which database requests provided to the policy executor 120′ correspond. Also shown are policy activation 160, statement cache 162, push-out manager 164, reports 165, and query warehouse 166. In one embodiment, the statement cache 162, push-out manager 164, and query warehouse 166 are incorporated into the system 100′. In one embodiment, the statement cache 162, push-out manager 164, and query warehouse 166 are preferably part of the extended database system 10″. In one embodiment, the query warehouse 166 is an optional component and may be provided as an additional feature. However, for ease of discussion, they have been depicted separately in FIG. 5. The statement cache 162 may be used to store information about statements that may be part of a database requests for fast access during use of the system 100. The push-out manager 164 may be used as an asynchronous thread to prevent the use of the system 100 from causing a potential delay in the processing path of database requests. The query warehouse 166 may be used to house any output, for example reports 165, provided as an optional part of implementation of policies using the system 100′.

FIG. 6 is a flow chart depicting another embodiment of a method 250 for managing a database system 10″ using policies. The method 250 is described in the context of the system 100′ and database system 10″. However, the method 250 may be used in conjunction with another system (not shown) that utilizes policies to manage a database system, such as the database system 10″.

One or more policies for use in managing the database system 10″ are defined, preferably by a policy manager 110′, via step 252. Step 252 is analogous to the step 202 of the method 200 depicted in FIG. 4. Referring back to FIGS. 5 and 6, the policies are provided by a user 19″ and/or by application(s) 18″ through the UI 12″. The policies may be stored on a file, a URL, database table, a pipe, cache memory, or other input media and provided to the system 100′ via the input media. As discussed above, the policies may be limited in scope or may be broad in scope. For example, the policies defined in step 252 may only be applicable for database requests by the user 19″ or application(s) 18″, may relate to all requests by any user 19″ of application(s) 18″ of a specific type, or may relate to the entire database system 10″. In some embodiments, any user 19″ may be able to define policies, at least in a limited context. However, in another embodiment, only a super user 19″ such as a database administrator may define and activate policies to avoid conflicts and chaos in database operations. In addition, the policies contain all elements used to define the policy (e.g. the scope, actions, and parameters used in the policy are defined).

Processing is performed on the policies, via step 254. This processing is preferably performed using the policy definition block 112. The processing includes analyzing the policies to perform consistency checking. This consistency checking determines whether there are conflicts between the policies and/or conflicts with preexisting policies having an overlapping scope. Any conflicts are resolved. If a conflict cannot be resolved, an error message may be provided. The policies are stored by the policy definition block 112, via step 256. The policy definition block 112 preferably stores the policies in tables. In one embodiment, a table corresponds to a particular set of policies.

The policies may then be activated, via step 258. Also in step 258, the policies are read into memory and stored, preferably as a policy tree or policy cache 113. The policy activation block 160 preferably activates the policies. In such an embodiment, the user 19″ (through the UI 12″) and/or application 18″ invokes the policy activation block for a particular set of policies. In a preferred embodiment, policy consistency checking and conflict resolution between policies, if any, might be done under policy activation block 258. Once activated, the policies control the behavior of the database system 10″ under certain conditions.

Database requests are received, via step 260. The database requests may include a request for any activity performed by the database system. In a preferred embodiment, the database requests are part of an input stream that may be provided from a user 19″ through the UI 12″ or from one or more of the application(s) 18″. Thus, the system 100′ preferably accesses the input stream to the database system 10″ from users 19″ via the UI 12″ and/or the application(s) 18″.

The database requests are analyzed to determine whether the one or more of the database requests are covered by some portion of the policies, via steps 262-268. In step 262, the policy executor 120′ preferably examines each database request. The policy executor 120′ calls the policy look-up block 114, via step 264. The policy look-up block 114 requests a look-up of the appropriate policy in the memory, which may be a policy tree or policy cache 113, by the policy definition block 112, via step 266. Based on this look-up and the database requests being examined, it is determined whether there is a match between the database requests and the scope of any of the active policies, via step 268. In steps 262-268, the policy executor 120′ may compare database requests with the statement cache 162 if necessary. If there is no match, then no policy is invoked and the method 250 terminates. Consequently, the underlying database engine 14″ may process the database request in a conventional manner.

However, if one or more database requests are covered by one or more of the policies, then the directives of the policies are carried out, via step 270. This is preferably accomplished through the policy enforcer 130′. In particular, the underlying database engine 14″ may process the database request in a conventional manner. However, in addition, the policy executor 120′ invokes the policy enforcer 130′. The policy enforcer 130′ would select the appropriate actions for the policies to which the database requests correspond and utilize the database system 10″, particularly the database engine 14″, to perform the actions.

The system 100′ and method 250 may be further understood with reference to specific examples. However one of ordinary skill in the art will readily recognize that the method 250 and system 100′ are not limited to such an example. Suppose a user 19″ wishes the following policies to apply to a database system: (1) monitor myPersonnel application and report the statistics for performance tuning; (2) monitor myERP application only for spikes in query execution time, where the particular execution time is either 250% greater or lower than the average execution time, and generate a detailed report when this happens; (3) limit the execution time of all queries defined under plan name P1, collection name COL1, and package name PKG1, to maximum of two minutes; stop the execution when this threshold is reached and generate a detailed report; and (4) monitor the execution time of all query run by authorized ID Tom submitted from IP address 9.30.45.50, and generate a report if the execution time exceeds 1 minutes. For simplicity only four policies are defined in this example. However, one of ordinary skill in the art will readily recognize that another number of policies having different directives may be used.

After defining these policies, they are input to and received by the system 100″ in step 252. Also in a preferred embodiment, step 252 is performed by a specific command that calls the policy manager 110′. In turn, the policy manager 110′ invokes the policy definition block 112 to read the policies being input in step 252. These policies would be processed and stored by the policy definition block 112 in steps 254 and 256. The policy definition block may also perform consistency checking and conflict resolution between policies, if any, in step 254. The policy definition 112 uses these verified policies to serve a look-up request from policy look-up 114. Therefore, to improve look-up performance, the verified policies may be stored as an efficient data structure in a cache, such as the policy cache 113, managed by policy definition block 112. Such a configuration may make the look-up process more efficient. In a preferred embodiment, these policies could be expressed in tabular form using a high level notation such as shown in Table 1.

TABLE 1

| Policy | | | |
|---|---|---|---|
| Number | Scope | Action | Parameters |
| 1 | myPersonnel | MONITOR | Report granularity |
| | application | | level 3 |
| 2 | myERP application | MONITOR SPIKE | 250% difference, |
| | | | report granularity |
| | | | level 15 |
| 3 | Plan P1, Collection | LIMITS CPU, STOP | 2 minutes, report |
| | COL1, | the Query | granularity level |
| | Package PKG1 | | 15 |
| 4 | Auth-ID Tom, IP | MONITOR CPU | 1 minutes, report |
| | address 9.30.45.50 | | granularity level 3 |

Note that policies 1, 2, and 4 are apparently in a group having to do with monitoring, while policy 3 is in a group having to do with resource limits. The data collection and reporting group complements the other groups by supporting the specification of the desired level of granularity for the report. In the example above, the granularity of the report is allowed to vary to a maximum of 15. The scopes of the policies include applications, plan with collection and package, and authorization ID with IP address. However, other scopes based on different criteria may also be used.

In this example, the policies are normalized and represented in two database tables. The profile tables are used to represent the scope applicable for a set of actions, whereas the actions and parameters are recorded in the profile attributes table. Two additional analogous history tables may be used by the system 100′ and the method 250 to record the history of which policies are active at any given time period. This policy history maybe used for diagnostics and might be shipped directly to the service team with other associated information. As can be seen in Table 1, the actions associated with the four policies are: MONITOR normal query execution; MONITOR exceptions such as ASUTIME, SPIKE, and CARDINALITY; LIMITS the resource usage, such as CPU; set various system optimization parameters, such as STAR JOIN, MINIMUM START JOIN TABLES, PAGES THRESHOLD; and provide specific optimization hints. Note that the actions for either the same or different groups can be added without interfering with the existing policies. Further, the actions for policies are not limited to those described herein, but could include other and/or additional actions.

In a preferred embodiment, after step 256, the policies are stored in tables in the policy definition block 112 but not yet activated. Stated differently, the system 100′ is not activated yet. Instead, explicit activation and deactivation commands are used to avoid an inadvertent increase in overhead due to the system 100′ and method 250. Thus, in step 258 a user 19″ activates the policies of Table 1. The user 19″ preferably invokes policy activation block 160 to activate the policy in step 258. In a preferred embodiment, a specific command is provided for activating the policies, and another particular command for deactivating the policies. In addition, other commands may be used to check if the policy is active and report additional information. In a preferred embodiment, the policies are activated by the policy activation 160 calling the policy manager 110′. In one embodiment, the policy manager 110 may also perform consistency checking and conflict resolution between policies, if any, in step 258.

Once the policies are activated, the database requests, which are provided to the policy executor 120′ and, in steps 262-266, are examined to determine whether a match with any scope of any of the policies is found. To do so, the policy executor 120′ calls the policy look-up block 114 to determine whether there is an active policy affecting the current request or query. If so, the specific policy, for example policy 1, will affect this database request. Consequently, through step 270 the actions of policy 1 will be carried out. Thus, in addition to the database system 10″ processing the database request, the policy executor 120′ invokes the policy enforcer 130′ to carry out the MONITOR action. If another of policy 1, 2, 3, and 4 were found to match a database request, then the action for that policy would be carried out by the policy enforcer 130′. As a result, the query is monitored and a report with granularity level three is produced. In the embodiment shown, the report generation is initiated by a report generator 141 in the extension of database engine 14″ and produced by the push-out manager 164. Such a report might be directed to a file, a stream, a database table, an active listener, a pipe, an e-mail, a queue, or other output media. In addition, the report may be further processed as part of the query warehousing facility 166, if such a facility is provided. In the example above in which the monitor action is performed and the report of granularity level three provided, the report might be realized into several tables.

Thus, the system 100′ and method 250 enjoy substantially the same benefits as the system 100 and method 200. In particular, policies may be provided by user(s) 19″ and/or application(s) 18′ and implemented where appropriate. The system 100′ and method 250 thus provide for a policy framework that is open, flexible, extensible, and allows more policy domains to be added without disrupting the existing support. Moreover, because the system 100′ and method 250 perform no additional functions when a database request is not within the scope of a policy, additional overhead used by the system 100′ and method 250 may be limited. Although described in the context of the database system 10′, the system 100′, method 250, and corresponding policies may be applicable to other computer systems and/or applications.

A method and system for managing a database system are described. The method and system have been described in accordance with the exemplary embodiments shown, and one of ordinary skill in the art will readily recognize that there could be variations to the embodiments, and any variations would be within the spirit and scope of the method and system. Accordingly, many modifications may be made by one of ordinary skill in the art without departing from the spirit and scope of the appended claims.

We claim:

1. A system for managing a computer system, the system comprising:
a policy manager for defining and storing a policy, the policy being a declarative statement of a directive to be carried out by the computer system;
a policy executor for determining whether the policy covers a request to the computer system; and
a policy enforcer for utilizing the computer system to carry out the directive for the policy if the request is covered by the policy.

2. The system of claim 1 wherein the computer system is a database system.

3. The system of claim 1 wherein the policy manager further resolves conflicts between the policy and another policy.

4. The system of claim 1 wherein the policy manager receives the policy from at least one of an authorized user and an application.

5. The system of claim 1 wherein the policy manager further looks up the policy.

6. The system of claim 1 wherein the computer system is a database system including a database engine, the database engine being coupled with the policy enforcer and for performing the directive.

7. The system of claim 1 wherein the policy belongs to a group indicating a portion of a plurality of activities carried out by the computer system.

8. The system of claim 7 wherein the policy manager further defines and stores an additional policy, the additional policy being an additional declarative statement of an additional directive to be carried out by the database system, the policy executor determines whether the policy covers the request and the policy enforcer for utilizes the computer system to carry out the additional directive for the additional policy if the request is covered by the additional policy, and wherein the additional policy belongs to an additional group.

9. The system of claim 1 wherein the group includes at least one of monitoring and tuning.

10. The system of claim 1 wherein the policy includes a scope indicating a portion of a plurality of computer system activities to which the policy covers.

11. The system of claim 10 wherein the computer system is a database system and wherein the scope includes at least one of an application, a plurality of applications, at least one query, and at least one user.

12. The system of claim 1 wherein the policy further includes at least one action corresponding to the directive.

13. The system of claim 1 wherein the policy further includes at least one parameter for further specifying the at least one action.

14. The system of claim 1 wherein the policy manager stores the policy in a table.

15. A system for managing performance in a database system including a database engine, the system comprising:
a policy manager for defining a plurality of policies, storing the plurality of policies in a table, activating and deactivating policies, resolving conflicts between the plurality of policies, and performing a look-up for each of the plurality of policies, each of the plurality of policies corresponding to a group and including a scope, at least one action, and at least one parameter, the at least one action corresponding to a directive to be carried out by the database system;
a policy executor coupled with the policy manager, the policy executor receiving a plurality of database requests and for determining whether the each of the plurality of database requests are within the scope of at least one of the plurality of policies; and
a policy enforcer for utilizing the database engine to carry out the directive for each of the plurality of database requests within the scope of the at least one of the plurality of policies.

16. A method for managing performance in a computer system, the method comprising:
defining a policy, the policy being a declarative statement of a directive to be carried out by the computer system;
storing the policy;
determining whether the policy covers a request to the computer system policy; and
carrying out the directive for the policy if the request is covered by the policy.

17. The method of claim 16 further comprising:
determining whether a conflict exists between the policy and an other policy;
resolving the conflict between the policy and the other policy if possible; and
wherein the storing further includes
storing the policy only if the conflict is resolved; and
providing an error message if the conflict is not resolved.

18. The method of claim 16 further comprising:
looking up the policy if it is determined that the request is covered by the policy.

19. The method of claim 16 wherein the receiving further includes:
receiving the policy from at least one of an authorized user and an application.

20. The method of claim 16 wherein the policy belongs to a group indicating a portion of a plurality of activities carried out by the computer system.

21. The method of claim 16 wherein the policy includes a scope indicating a portion of a plurality of computer system activities to which the policy corresponds.

22. The method of claim 21 wherein the computer system is a database system and wherein the scope includes at least one of an application, a plurality of applications, at least one query; and at least one user.

23. The method of claim 16 wherein the policy further includes at least one action corresponding to the directive.

24. The method of claim 16 wherein the policy further includes at least one parameter for further specifying the at least one action.

25. The method of claim 16 further comprising:
activating the policy.

26. A method for managing performance in a database system including a database engine, the method comprising:
receiving a plurality of policies from at least one of an authorized user and an application, each of the plurality of policies corresponding to a group and including a scope, at least one action, and at least one parameter, the at least one action corresponding to a directive to be carried out by the database system;
resolving conflicts between the plurality of policies,
storing the plurality of policies in a table;
activating at least a portion of the plurality of policies;
determining whether the each of a plurality of database requests is within the scope of at least one of the plurality of policies;
performing a look-up for each of the at least one of the policies for each of the plurality of database requests is within the scope of the at least one of the plurality of policies;
utilizing the database engine to carry out the directive for each the plurality of policies having a scope within which any of the plurality of database requests is.

27. A computer-program product including a program for managing performance in a computer system, the program including instructions for:
receiving a policy, the policy being a declarative statement of a directive to be carried out by the computer system;
storing the policy;
determining whether the policy covers a request to the computer system; and
carrying out the directive for the policy if the request is covered by the policy.

28. The computer-program product of claim 27 wherein the computer system is a database system.

29. The computer-program product of claim 27 wherein the program further includes instructions for:
determining whether a conflict exists between the policy and an other policy;
resolving the conflict between the policy and the other policy if possible; and
wherein the storing further includes
storing the policy only if the conflict is resolved; and
providing an error message if the conflict is not resolved.

30. The computer-program product of claim 27 wherein the program further includes instructions for:
looking up the policy if it is determined that the request is covered by the policy.

31. The computer-program product of claim 27 wherein the receiving instructions further include instructions for:
receiving the policy from at least one of an authorized user and an application.

32. The computer-program product of claim 27 wherein the policy belongs to a group indicating a portion of a plurality of activities carried out by the computer system.

33. The computer-program product of claim 27 wherein the policy includes a scope indicating a portion of a plurality of computer system activities to which the policy corresponds.

34. The computer-program product of claim 27 wherein the policy further includes at least one action corresponding to the directive.

35. The computer-program product of claim 27 wherein the policy further includes at least one parameter for further specifying the at least one action.
